(19) United States
(12) Patent Application Publication
(10) Pub. No.: US 2002/0114022 A1
(43) Pub. Date: Aug. 22, 2002

(54) Image input apparatus, recording medium and image synthesis method

(76) Inventors: Sachio Tanaka, Nara-shi (JP); Toshio Nishimura, Kyotanabe-shi (JP)

Correspondence Address: BIRCH STEWART KOLASCH & BIRCH, PO BOX 747, FALLS CHURCH, VA, 22040-0747, US

(21) Appl. No.: 10/024,184

(22) Filed: Dec. 21, 2001

(30) Foreign Application Priority Data
Dec. 27, 2000 (JP) 2000-399628

(51) Int. Cl. H04N 1/04

(52) U.S. Cl. 358/496; 358/497

(57) ABSTRACT

An image input apparatus having a scanning surface used for scanning a document, the image input apparatus includes an image reading section for reading an image of the document facing the scanning surface; a position detection section for detecting a moving direction and a movement amount of the image input apparatus; and a control section for controlling the image reading section and the position detection section so that detection is performed by the position detection section in synchronization with image reading performed by the image reading section.

### BACKGROUND OF THE INVENTION

1. Field of the Invention

The present invention relates to an image input apparatus used for manually scanning a document so as to read an image, i.e., a handheld scanner, a recording medium which stores a program for synthesizing image information using the same, and an image synthesis method for performing image synthesis using the image input apparatus.

2. Description of the Related Art

A recent handheld scanner includes a CCD line image sensor and two rollers respectively provided at two ends of the CCD line image sensor. The CCD line image sensor is used for reading an image of a document in a main scanning direction. The rollers are used for detecting the movement of the scanner in a direction perpendicular to the main scanning direction. A group of one-dimensional image information units which are read by the line image sensor are synthesized into a two-dimensional image information group by calculating a coordinate value of each one-dimensional image information unit based on the movement amount of the handheld scanner obtained by the rollers.

Japanese Laid-Open Publication No. 2-51971 discloses a technique for solving a reading error of an image caused by the meandering of the scanner. According to this technique, the meandering degree of the scanner is detected based on a difference in the rotating amounts of the two rollers, and correction is made when images are synthesized.

Japanese Laid-Open Publication No. 2000-20230 discloses a scanning technique which does not use mechanical components. According to this technique, an image taken by an optical position detector built in an optical mouse is sent to a host computer. Thus, the optical mouse acts as a scanner.

The above-described conventional handheld scanners have the following problems.

In a structure of a scanner or detecting the movement thereof using the rollers, the movement only in a direction perpendicular to the main scanning direction can be detected. Therefore, the scanner needs to be moved straight in that direction. A width of an image obtained in one cycle of manual operation is equal to the width of the line image sensor. An image having a width greater than the width of the line image sensor cannot be scanned. Furthermore, when the rollers slip on the document to be read and thus the scanner meanders during the manual scanning operation, the rollers cannot detect the meandering of the scanner. Therefore, read images cannot be correctly synthesized.

The technique disclosed in Japanese Laid-Open Publication No. 2-51971 also uses rollers. Although accommodating for the meandering of the scanner caused by slipping of the rollers, this technique still limits the direction of movement of the scanner. Especially, the scanner cannot move in a direction perpendicular to the moving direction of the rollers. Furthermore, as the scanner is repetitively used, dust on a face on which the scanner moves adheres to the rollers. When the dust enters the inside of the scanner, the components of the scanner malfunction and the rollers slip. In order to prevent these inconveniences, periodical checking of the scanner is required. Additionally, the mechanical components, such as the rollers, are expensive to produce and are also difficult to be integrated with the scanner.

The technique disclosed in Japanese Laid-Open Publication No. 2000-20230 uses an imaging section of the optical position detector, instead of the line image sensor, as means for reading an image of a document. The imaging section can only take an image of a narrow area. This technique does not take into consideration the meandering movements, movement in a curve or other movements of the scanner, and thus requires the scanner to be moved completely in the same direction. Thus, it is practically impossible to read a large image with this technique.

### SUMMARY OF THE INVENTION

According to one aspect of the invention, an image input apparatus having a scanning surface used for scanning a document includes an image reading section for reading an image of the document facing the scanning surface; a position detection section for detecting a moving direction and a movement amount of the image input apparatus; and a control section for controlling the image reading section and the position detection section so that detection is performed by the position detection section in synchronization with image reading performed by the image reading section.

In one embodiment of the invention, the scanning surface includes a line area extending in a main scanning direction, and a first reference point and a second reference point each located so as to have a predetermined positional relationship with respect to the line area. The image reading section includes a line image sensor for reading the image of the document facing the line area. The position detection section includes a first optical position detector for detecting a movement amount of the first reference point in the main scanning direction and a movement amount of the first reference point in a direction perpendicular to the main scanning direction, and a second optical position detector for detecting a movement amount of the second reference point in the main scanning direction and a movement amount of the second reference point in a direction perpendicular to the main scanning direction.

In one embodiment of the invention, the first reference point is located on a straight line extending in the main scanning direction from one of two ends of the line area, and the second reference point is located on a straight line extending in the main scanning direction from the other end of the line area.

In one embodiment of the invention, the image input apparatus further includes an image synthesis section for synthesizing a plurality of images read by the image reading section into one image based on a detection result obtained by the position detection section.

In one embodiment of the invention, the image synthesis section calculates a post-movement coordinate value based on a pre-movement coordinate value and the detection result obtained by the position detection section.

In one embodiment of the invention, the image reading section reads a plurality of images for one coordinate value, and the image synthesis section performs image synthesis based on the latest image read among the plurality of images read for the one coordinate value.

In one embodiment of the invention, the image input apparatus further includes a determination section for determining whether or not there is an unread area of the document; and a notification section for notifying a user of the image input apparatus of the determination result obtained by the determination section.

According to another aspect of the invention, a computer readable recording medium storing a program for causing a computer to execute image synthesis processing is provided. The computer is constructed to be connectable to an image input apparatus having a scanning surface used for scanning a document. The image input apparatus includes an image reading section for reading an image of the document facing the scanning surface, a position detection section for detecting a moving direction and a movement amount of the image input apparatus, and a control section for controlling the image reading section and the position detection section so that detection is performed by the position detection section in synchronization with image reading performed by the image reading section. The image synthesis processing includes the step of synthesizing a plurality of images read by the image reading section into one image based on a detection result obtained by the position detection section.

According to still another aspect of the invention, an image synthesis method for performing image synthesis using an image input apparatus having a scanning surface used for scanning a document is provided. The image synthesis method includes the steps of reading an image of the document facing the scanning surface; detecting a moving direction and a movement amount of the image input apparatus; detecting the moving direction and the movement amount of the image input apparatus in synchronization with image reading performed by the image reading section; and synthesizing a plurality of images read by the image reading section into one image based on a detection result obtained by the position detection section.

According to the present invention, positional information, indicating in which direction and by how long a distance the image input apparatus has moved or in which direction the image input apparatus is currently located, is obtained by the position detection section. In synchronization with acquirement of the positional information on the image input apparatus, the image reading section reads an image of a document. In this manner, the positional information on the image input apparatus can be associated with the image information read by the image reading section. As a result, the image input apparatus is allowed to freely move on the document with no limit as to the moving direction. Therefore, a large image having a greater width than the width of the line image sensor can be read. The image input apparatus is also allowed to move in a curve, for example, to meander or to pivot about an axis in a direction perpendicular to the plane of the document. Even when the image input apparatus is moved in such a manner, images can be correctly synthesized.

Since the first and second optical position detectors are used to perform position detection, mechanical components such as rollers are not required. Therefore, the image input apparatus is inexpensive to produce and is easy to maintain.

When a plurality of images are read for one coordinate value, image synthesis is performed based on the latest image. Therefore, even when a part of the image cannot be correctly read, the read image can be recovered by scanning that part again. Since the previously read image for the same coordinate value need not be stored, the memory is not required to have extra capacity. This simplifies the structure of the image input apparatus.

Since it is determined whether or not there is still an unread area and the determination result is notified to the user, simple operation errors are not left without being corrected.

The initial position from which image reading is begun is set on the document. Therefore, an area having no image to read is clearly determined, and thus the memory capacity can be saved.

The initial direction of the image input apparatus when image reading is begun is set on the document. Therefore, the extra step of, when the read image is not in the intended direction, processing the image using different software or the like is eliminated.

Thus, the invention described herein makes possible the advantages of providing an image input apparatus which correctly reads an image on a document and synthesizes images even when being moved without limitation in movement direction, and which can be produced and maintained at low cost, a recording medium which stores a program for synthesizing image information using the same, and an image synthesis method for performing image synthesis using the image input apparatus.

These and other advantages of the present invention will become apparent to those skilled in the art upon reading and understanding the following detailed description with reference to the accompanying figures.

### BRIEF DESCRIPTION OF THE DRAWINGS

FIG. 1 shows an external appearance of an image input apparatus (handheld scanner 100) according to an example of the present invention;

FIG. 2 shows an exemplary structure of a scanning surface 100a of the handheld scanner 100;

FIG. 3 is a block diagram illustrating an exemplary component structure of the handheld scanner 100;

FIG. 4A is a block diagram illustrating an exemplary component structure of the handheld scanner 100 and a host computer 1502;

FIG. 4B is a block diagram illustrating another exemplary component structure of the handheld scanner 100 and a host computer 1502;

FIG. 5 shows an exemplary inner structure of the handheld scanner 100;

FIG. 6 shows an arrangement of optical position detectors 301 and 302 and an image sensor line 406 of the handheld scanner 100;

FIG. 7 is a flowchart illustrating an operation of the optical position detectors 301 and 302;

FIG. 8 is a schematic view showing a state where the handheld scanner 100 is moved from an initial position by a very short or fine distance;

FIG. 9 is a schematic view showing a state where the handheld scanner 100 is moved from an arbitrary position by a fine distance;

FIG. 10 is a flowchart illustrating a process of calculating absolute coordinate values according to the present invention;

FIG. 11 is a flowchart illustrating a process for sending image information to a memory 308 of the handheld scanner 100;

FIG. 12 shows a flow of processing from when an image is taken by the optical position detectors 301 and 302 until image information is stored in the memory 308;

FIG. 13 shows how the handheld scanner 100 is moved on a document for image reading;

FIG. 14A shows an example of image information stored in the memory 308 through the scanning of the document shown in FIG. 13;

FIG. 14B shows another example of image information stored in the memory 308 through the scanning of the document shown in FIG. 13;

FIG. 14C shows a content of information stored in the memory 308, which indicates whether image information has been processed or unprocessed;

FIG. 15A shows an example of driver software for setting a size of a document displayed on a screen of the host computer; and

FIG. 15B shows an example of driver software for setting an initial position of the handheld scanner displayed on a screen of the host computer.

### DESCRIPTION OF THE PREFERRED EMBODIMENTS

Hereinafter, the present invention will be described by way of illustrative examples with reference to the accompanying drawings.

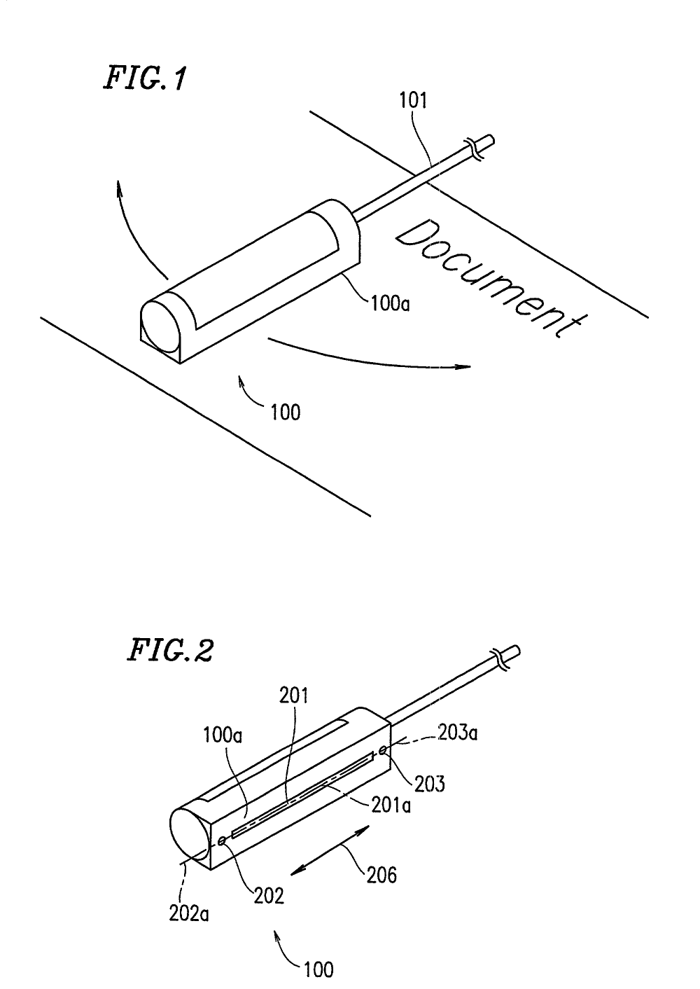

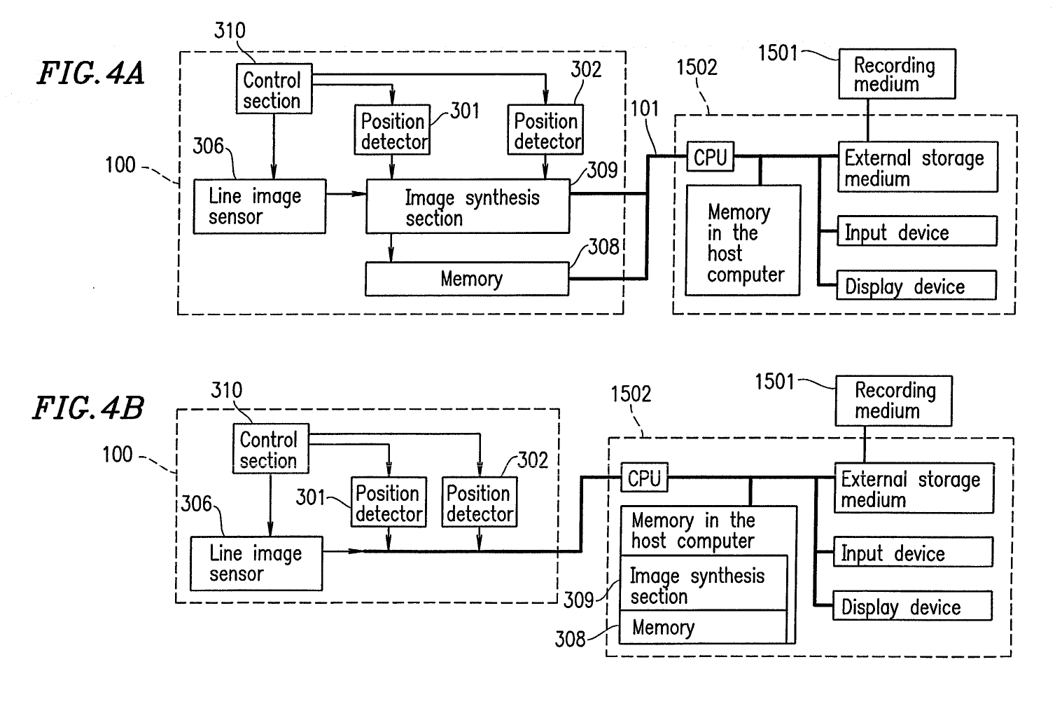

FIG. 1 shows an external appearance of an image input apparatus (handheld scanner) 100 according to an example of the present invention. The handheld scanner 100 has a scanning surface 100a used for scanning a document and is constructed so as to read an image of a document facing the scanning surface 100a. The handheld scanner 100 is movable in a curve at any angle over 360 degrees. An output from the handheld scanner 100 is supplied to a host computer (not shown in FIG. 1, see FIGS. 4A and 4B) via a cable 101. Instead of a wired system using the cable 101, a wireless system using, for example, infrared rays, can be adopted.

FIG. 2 show an exemplary structure of the scanning surface 100a. In this example, the scanning surface 100a is a bottom surface of the handheld scanner 100. The scanning surface 100a has a slit 201 used for a line image sensor, an opening 202 of a first optical position detector, and an opening 203 of a second optical position detector. The slit 201 extends in a main scanning direction 206 of the handheld scanner 100. The openings 202 and 203 are each located so as to have a predetermined positional relationship with respect to the slit 201. In the example shown in FIG. 2, the opening 202 is located on a straight line 202a extending in the main scanning direction 206 from one end of the slit 201, and the opening 203 is located on a straight line 203a extending in the main scanning direction 206 from the other end of the slit 201. A center line 201a of the slit 201, the straight line 202a and the straight line 203a can be a part of the same line.

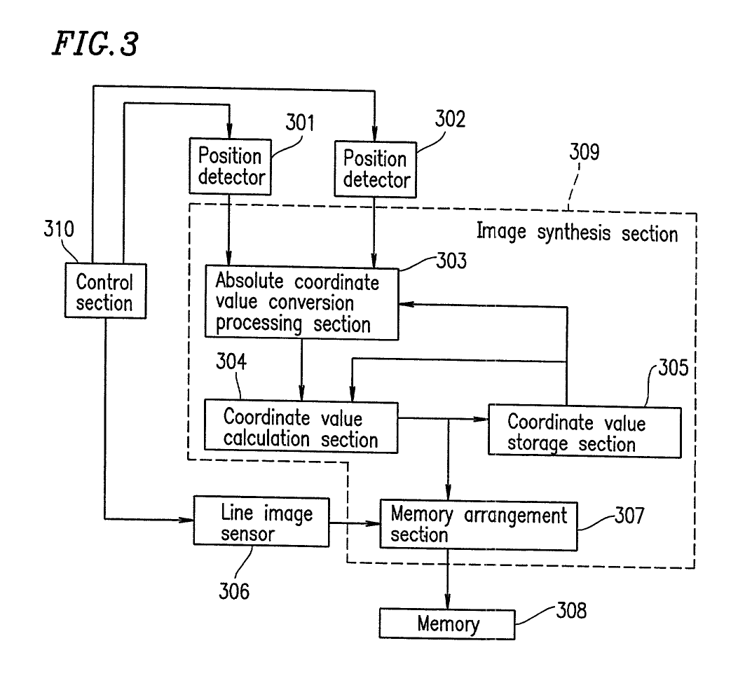

FIG. 3 shows an exemplary component structure of the handheld scanner 100.

The handheld scanner 100 includes an optical position detector 301 (the first optical position detector), an optical position detector 302 (the second optical position detector), a line image sensor 306, an image synthesis section 309, a memory 308 and a control section 310.

The line image sensor 306 is provided on the scanning surface 100a for reading an image of a document facing a line area extending in the main scanning direction 206 (FIG. 2). The line area is, for example, an area defined by the slit 201. Thus, the line image sensor 306 acts as an image reading section for reading an image of a document facing the scanning surface 100a.

The optical position detector 301 detects a movement amount (i.e., movement distance) of a first reference point on the scanning surface 100a (for example, the center point of the opening 202) in the main scanning direction 206 and a moving direction of the first reference point in a direction perpendicular to the main scanning direction 206.

The second optical position detector 302 detects a movement amount of a second reference point on the scanning surface 100a (for example, the center point of the opening 203) in the main scanning direction 206 and a moving direction of the second reference point in a direction perpendicular to the main scanning direction 206.

Thus, the optical position detector 301 and the optical position detector 302 each act as a position detector for detecting a movement amount of the handheld scanner 100 in relation to a moving direction.

The first reference point and the second reference point are each located so as to have a predetermined positional relationship with respect to the line area. For example, the first reference point can be located on a straight line extending in the main scanning direction 206 from one end of the line area, and the second reference point can be located on a straight line extending in the main scanning direction 206 from the other end of the line area.

The control section 310 controls the line image sensor 306 (image reading section) and the optical position detectors 301 and 302 (position detection section) so that position detection is performed by the optical position detectors 301 and 302 (position detection section) in synchronization with image reading performed by the line image sensor 306 (image reading section). Such control is achieved by, for example, synchronizing the timing of reading an image and the timing of detecting the movement amounts of the handheld scanner 100. The control section 310 can be incorporated into at least one of the optical position detector 301, the optical position detector 302 and the line image sensor 306.

In the following description, the main scanning direction will be referred to as a “p direction”, and a direction perpendicular to the main scanning direction will be referred to as a “q direction”.

By moving the handheld scanner 100 on a document by a very short or fine distance, a fine movement amount of the first reference point in the p direction and a fine movement amount of the first reference point in the q direction are detected by the optical position detector 301. A fine movement amount of the second reference point in the p direction and a fine movement amount of the second reference point in the q direction are detected by the optical position detector 302. Data on the fine movement amounts in the p direction and the q direction is output to the image synthesis section 309.

Based on the data on the fine movement amounts in the p direction and the q direction, the image synthesis section 309 synthesizes a plurality of images read by the line image sensor 306 into one image. The image synthesis section 309 includes an absolute coordinate value conversion processing section 303, at coordinate value calculation section 304, a coordinate value storage section 305, and a memory arrangement section 307.

The absolute coordinate value conversion processing section 303 converts the data on the fine movement amounts in the p direction and the q direction (relative movement amounts) into fine movement amounts on an absolute coordinate system (i.e., fine movement amounts in an x direction and a y direction). The absolute coordinate system is a coordinate system which does not rely on the movement of the handheld scanner 100. For conversion, the absolute coordinate value conversion processing section 303 refers to absolute coordinate values of the handheld scanner 100 before the movement (pre-movement absolute coordinate values). The pre-movement absolute coordinate values of the handheld scanner 100 are sent to the absolute coordinate value conversion processing section 303 from the coordinate value storage section 305 which stores the pre-movement absolute coordinate values of the handheld scanner 100.

Data on the fine movement amounts on the absolute coordinate system obtained in this manner is output to the coordinate value calculation section 304.

The coordinate value calculation section 304 calculates absolute coordinate values of the handheld scanner 100 after the movement (post-movement absolute coordinate values) by determining a sum of the data on the fine movement amounts on the absolute coordinate system and the pre-movement absolute coordinate values of the handheld scanner 100. The post-movement absolute coordinate values are output to the memory arrangement section 307 and also to the coordinate value storage section 305 for the next coordinate value calculation.

In this specification, the expression “pre-movement” refers to a state before the handheld scanner 100 is moved, and the expression “post-movement” refers to a state after the handheld scanner 100 is moved.

The line image sensor 306 generates M-dot image information in correspondence with a reading resolution thereof. The generated image information is output to the memory arrangement section 307 of the image synthesis section 309. In accordance with the absolute coordinate values obtained by the coordinate value calculation section 304, the memory arrangement section 307 outputs the image information to an appropriate address in the memory 308.

FIG. 4A shows an exemplary component structure of the handheld scanner 100 and a host computer 1502. The handheld scanner 100 is connected to the host computer 1502 via the cable 101.

The structure of the handheld scanner 100 shown in FIG. 4A is identical to that of FIG. 3.

The host computer 1502 includes a CPU, a memory, an external storage device, an input device, and a display device. The host computer 1502 performs, for example, installment and execution of driver software stored in a recording medium 1501, input of various items and parameters, processing of data output from the handheld scanner 100, and display of the processed data.

It is not necessary that the handheld scanner 100 includes all of the sections shown in FIG. 3. For example, the memory 308 or the image synthesis section 309 can be excluded from the handheld scanner 100.

FIG. 4B shows another exemplary component structure of the handheld scanner 100 and the host computer 1502. In the example shown in FIG. 4B, the handheld scanner 100 does not include the memory 308 or the image synthesis section 309. In the example shown in FIG. 4B, a part of the memory in the host computer 1502 has the function of the memory 308. The function of the image synthesis section 309 is implemented by installing an image synthesis program, stored in the recording medium 1501, into the host: computer 1502 and executing the program.

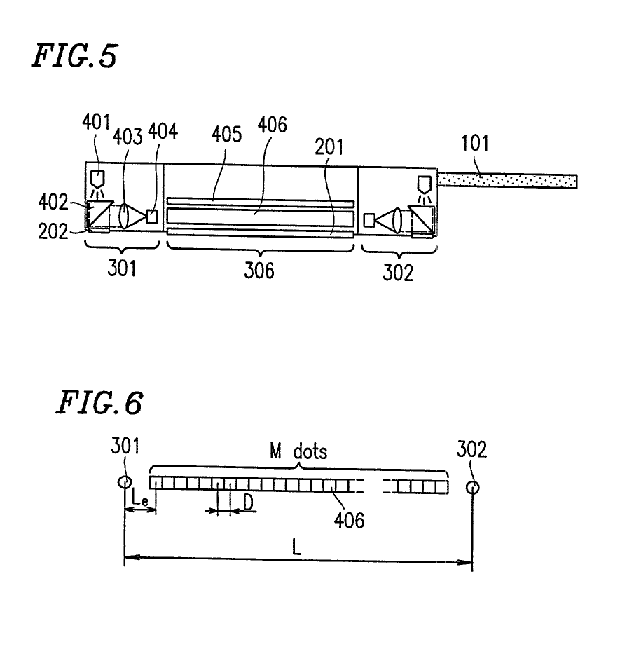

FIG. 5 shows an exemplary inner structure of the handheld scanner 100. In this example, the line image sensor 306 interposes the optical position detectors 301 and 302.

The line image sensor 306 includes a white light source 405 for irradiating a document with high luminance light through the slit 201 and an image sensor line 406 for receiving the light reflected by the document and generating image information based on the reflected light. As shown in FIG. 6, the image sensor line 406 includes M image sensors arranged in a straight line, where M is an integer of equal to or greater than 2.

In FIG. 6, “D” represents an interval between the centers of two adjacent image sensors, and “L” represents a distance between the optical position detectors 301 and 302 provided on a straight line extending from each end of the image sensor line 406. “Lₑ” represents a distance between the optical position detector 301 and the center of the image sensor line 406.

Referring to FIG. 5, the optical position detectors 301 and 302 have an identical structure. Herein, the structure of the optical position detectors 301 will be described, and the description of the structure of the optical position detectors 302 will be omitted.

The optical position detector 301 includes a light source 401 (for example, an LED) for emitting high luminance light, a prism 402, an imaging lens 403, and an imaging element 404.

Light emitted by the light source 401 is directed to a document (not shown) through the prism 402 and the opening 202. The light reflected by the document is refracted by the prism 402 and focused on the imaging element 404 by the imaging lens 403.

The optical position detectors 301 and 302 continuously take portions of an image of the document (more specifically, portions seen through the openings 202 and 203). Based on the correlation of these images, the optical position detectors 301 and 302 detect the movement amounts of the handheld scanner 100 in relation to the moving directions.

For example, images, each of which is offset by one dot in one of eight different directions with respect to the image before the handheld scanner 100 is moved (pre-movement image), are prepared. When an image after the movement of the handheld scanner 100 (post-movement image) is obtained, the post-movement image is compared with the pre-movement image and eight images prepared as above. The image which is least different from the pre-movement image is selected, thus specifying the moving direction of the handheld scanner 100. In consideration of the movement in a curve of the handheld scanner 100 (about a z axis which is perpendicular to an x-y plane or the plane of the document), it is preferable to prepare images which would be obtained by translating and moving the handheld scanner 100 in a curve and to determine correlation between the images. This series of operations is repeated for a certain time period. Thus, a distance by which the handheld scanner 100 moves in a unit time is obtained both for the p direction and for the q direction. Here, Δp₁ᵢ is a movement distance in the p direction detected by the optical position detector 301 in a unit time after pre-movement instant i, and Δq₁ᵢ is a movement distance in the q direction detected by the optical position detector 301 in a unit time after pre-movement instant i. Δp₂ᵢ is a movement distance in the p direction detected by the optical position detector 302 in a unit time after pre-movement instant i, and Δq₂ᵢ is a movement distance in the q direction detected by the optical position detector 302 in a unit time after pre-movement instant i.

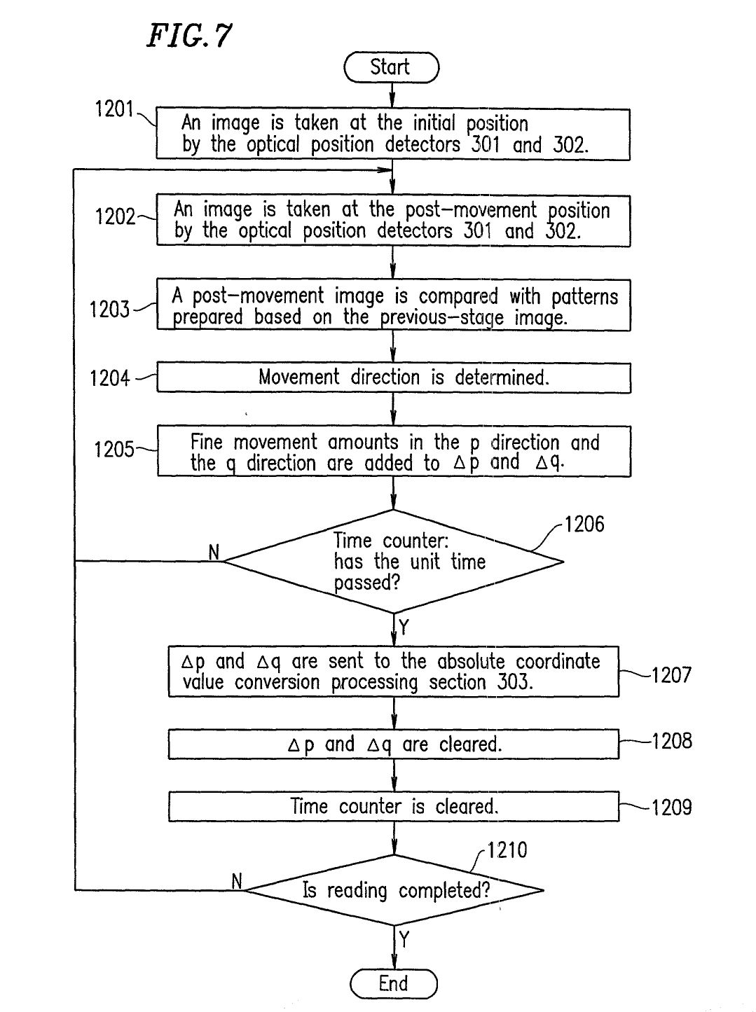

FIG. 7 is a flowchart illustrating the operation of the optical position detectors 301 and 302.

First, the optical position detectors 301 and 302 take a first image at an initial position (step 1201). The handheld scanner 100 starts to move from the initial position. The optical position detectors 301 and 302 take a second image at a position after the movement (step 1202). Based on the pre-movement images, images which would be obtained by translating the handheld scanner 100 by 0 to several dots (in accordance with the resolution or the imaging cycle) and patterns which would be obtained by pivoting the handheld scanner 100 about the z axis are prepared, and these patterns are compared with the post-movement images (step 1203). Among these patterns, one image which is closest to the post-movement image is selected, and thus the moving direction of the handheld scanner 100 is determined (step 1204). When the moving direction is determined, a movement distance of a component in the p direction and a movement distance of a component in the q direction are stored. When previous values are already stored, the newly determined values are added to the previously stored values (step 1205). After such a routine is completed, a time counter is checked (step 1206). In the case where the certain time period has passed, the movement amounts (movement distances) in the p and q directions are sent to the absolute coordinate value conversion processing section 303 (step 1207). In the case where the certain time period has not passed, the optical position detectors 301 and 302 each take another image at the next position, and the above-described routine until the addition of the values (step 1205) is repeated. After the movement distances in the p and q directions are sent to the absolute coordinate value conversion processing section 303, the movement distance Δp and Δq in the p and q directions accumulated so far are returned to zero (step 1208), and the time counter is returned to zero (step 1209). Then, it is determined whether or not the reading operation is completed (step 1210). When the reading operation is completed, processing is terminated. When the reading operation has not been completed, processing returns to step 1202 and still another image is taken at the next position. Whether or not the reading operation is completed is notified by the handheld scanner 100 or the host computer 1502 to the user.

Hereinafter, absolute coordinate value conversion processing for converting the movement distances (Δp₁ᵢ, Δq₁ᵢ) detected by the optical position detector 301 and the movement distances (Δp₂ᵢ, Δq₂ᵢ) detected by the optical position detector 302 into movement distances on an absolute coordinate system will be described.

FIG. 8 shows a state where the handheld scanner 100 placed parallel to the bottom side of the document (initial position) moves in one unit time from the initial position. First, the position from which an image is to be read and the direction of the handheld scanner 100 at the start of image reading are determined. In the example of FIG. 8, image reading is begun in the state where the optical position detector 301 is at the position (0, 0) and the optical position detector 302 is at position (L, 0), where (0, 0) is the lower left corner of the document. When the handheld scanner 100 moves from this state, the distances detected by the optical position detector 301, i.e., (Δp₁₀, Δq₁₀), match the distances (Δx₁₀, Δy₁₀) on the absolute coordinate system. The distances detected by the optical position detector 302, i.e., (Δp₂₀, Δq₂₀), match the distances (Δx₂₀, Δy₂₀) on the absolute coordinate system. Therefore, the absolute coordinate values (x₁₁, y₁₁) and (x₂₁, y₂₁) after the movement of the handheld scanner 100 (post-movement absolute coordinate values) to be obtained are represented by following expression (1),

$$\{ \begin{matrix}{x}_{11} = Δ {p}_{10} \\ {y}_{11} = Δ {q}_{10}\end{matrix} \{ \begin{matrix}{x}_{21} = Δ {p}_{20} + L \\ {y}_{21} = Δ {q}_{20}\end{matrix} . \qquad ( 1 )$$

Now, the direction of the handheld scanner 100 after the movement is defined. Where an angle made by a vector extending from (x₁₁, y₁₁) to (x₂₁, y₂₁) and the x axis (i.e., inclination of the handheld scanner 100) is φ₁, following expression (2) is derived,

$$\{ \begin{matrix}cos {φ}_{1} = ( {x}_{21} - {x}_{11} ) / L \\ sin {φ}_{1} = ( {y}_{21} - {y}_{11} ) / L\end{matrix} . \qquad ( 2 )$$

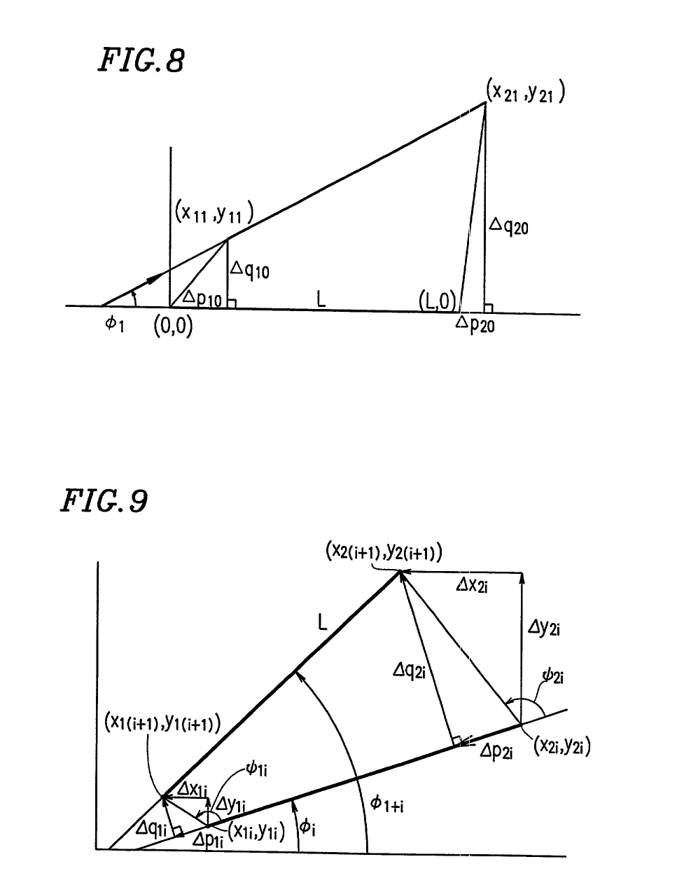

Next, referring to FIG. 9, the coordinate values of the handheld scanner 100 moving from one time point i to another time point i+1 is obtained. It is assumed that at time point i, the optical position detector 301 is at the position (x₁ᵢ, y₁ᵢ) and the optical position detector 302 is at the position (x₂ᵢ, y₂ᵢ). It is also assumed that by the next time point i+1, the optical position detector 301 detects movement distances (Δp₁ᵢ, Δq₁ᵢ) and the optical position detector 302 detects movement distances (Δp₂ᵢ, Δq₂ᵢ).

The inclination φ₁ of the handheld scanner 100 at time point i is represented by following expression (3) based on the absolute coordinate values of the optical position detectors 301 and 302,

$$\{ \begin{matrix}cos {φ}_{i} = ( {x}_{2 i} - {x}_{1 i} ) / L \\ sin {φ}_{i} = ( {y}_{2 i} - {y}_{1 i} ) / L\end{matrix} . \qquad ( 3 )$$

Where an angle made by the vector representing the locus of the movement of the optical position detector 301 and a vector extending from the position (x₁ᵢ, y₁ᵢ) to the position (x₂ᵢ, y₂ᵢ) is ψ₁ᵢ, ψ₁ᵢ is represented by following expression (4) based on the data Δp₁ᵢ and Δq₁ᵢ detected by the optical position detectors 301 and 302,

$$\{ \begin{matrix}cos {φ}_{1 i} = Δ {p}_{1 i} / \sqrt{Δ {p}_{1 i}^{2} + Δ {q}_{1 i}^{2}} \\ sin {φ}_{1 i} = Δ {q}_{1 i} / \sqrt{Δ {p}_{1 i}^{2} + Δ {q}_{1 i}^{2}}\end{matrix} . \qquad ( 4 )$$

Similarly, where an angle made by the vector representing the locus of the movement of the optical position detector 302 and a vector extending from the position (x₁ᵢ, y₁ᵢ) to the position (x₂ᵢ, y₂ᵢ) is ψ₂ᵢ, ψ₂ᵢ is represented by following expression (5) based on the data Δp₂ᵢ and Δq₂ᵢ detected by the optical position detectors 301 and 302,

$$\{ \begin{matrix}cos {φ}_{2 i} = Δ {p}_{2 i} / \sqrt{Δ {p}_{2 i}^{2} + Δ {q}_{2 i}^{2}} \\ sin {φ}_{2 i} = Δ {q}_{2 i} / \sqrt{Δ {p}_{2 i}^{2} + Δ {q}_{2 i}^{2}}\end{matrix} . \qquad ( 5 )$$

From FIG. 9, the movement amount of each optical position detector 301, 302 on the absolute coordinate system is represented as following expression (6),

$$\{ \begin{matrix} Δ {x}_{1 i} = \sqrt{Δ {p}_{1 i}^{2} + Δ {q}_{1 i}^{2}} cos ( {φ}_{i} + {φ}_{1 i} ) \\ = \sqrt{Δ {p}_{1 i}^{2} + Δ {q}_{1 i}^{2}} \{ cos {φ}_{i} cos {φ}_{1 i} - sin {φ}_{i} sin {φ}_{1 i} \} \\ Δ {y}_{1 i} = \sqrt{Δ {p}_{1 i}^{2} + Δ {q}_{1 i}^{2}} sin ( {φ}_{i} + {φ}_{1 i} ) \\ = \sqrt{Δ {p}_{1 i}^{2} + Δ {q}_{1 i}^{2}} \{ sin {φ}_{i} cos {φ}_{1 i} + cos {φ}_{i} sin {φ}_{1 i} \}\end{matrix} \\ \{ \begin{matrix} Δ {x}_{2 i} = \sqrt{Δ {p}_{2 i}^{2} + Δ {q}_{2 i}^{2}} cos ( {φ}_{i} + {φ}_{2 i} ) \\ = \sqrt{Δ {p}_{2 i}^{2} + Δ {q}_{2 i}^{2}} \{ cos {φ}_{i} cos {φ}_{2 i} - sin {φ}_{i} sin {φ}_{2 i} \} \\ Δ {y}_{2 i} = \sqrt{Δ {p}_{2 i}^{2} + Δ {q}_{2 i}^{2}} sin ( {φ}_{i} + {φ}_{2 i} ) \\ = \sqrt{Δ {p}_{2 i}^{2} + Δ {q}_{2 i}^{2}} \{ sin {φ}_{i} cos {φ}_{2 i} + cos {φ}_{i} sin {φ}_{2 i} \}\end{matrix} . \qquad ( 6 )$$

As shown by expression (6), the movement amounts (Δx₁ᵢ, Δy₁ᵢ) of the optical position detector 301 on the absolute coordinate system and the movement amounts (Δx₂ᵢ, Δy₂ᵢ) of the optical position detector 302 also on the absolute coordinate system are respectively represented by the pre-movement coordinate values (x₁ᵢ, y₁ᵢ) and (x₂ᵢ, y₂ᵢ) and the data (Δp₁ᵢ, Δq₁ᵢ) and (Δp₂ᵢ, Δq₂ᵢ) detected by the optical position detectors 301 and 3102. Accordingly, the post-movement coordinate values, i.e., (x₁₍ᵢ₊₁₎, y₁₍ᵢ₊₁₎) and (x₂₍ᵢ₊₁₎, y₂₍ᵢ₊₁₎) are represented by expression (7),

$$\{ \begin{matrix}{x}_{1 ( i + 1 )} = {x}_{1 i} + Δ {x}_{1 i} \\ {y}_{1 ( i + 1 )} = {y}_{1 i} + Δ {y}_{1 i}\end{matrix} \\ \{ \begin{matrix}{x}_{2 ( i + 1 )} = {x}_{2 i} + Δ {x}_{2 i} \\ {y}_{2 ( i + 1 )} = {y}_{2 i} + Δ {y}_{2 i}\end{matrix} . \qquad ( 7 )$$

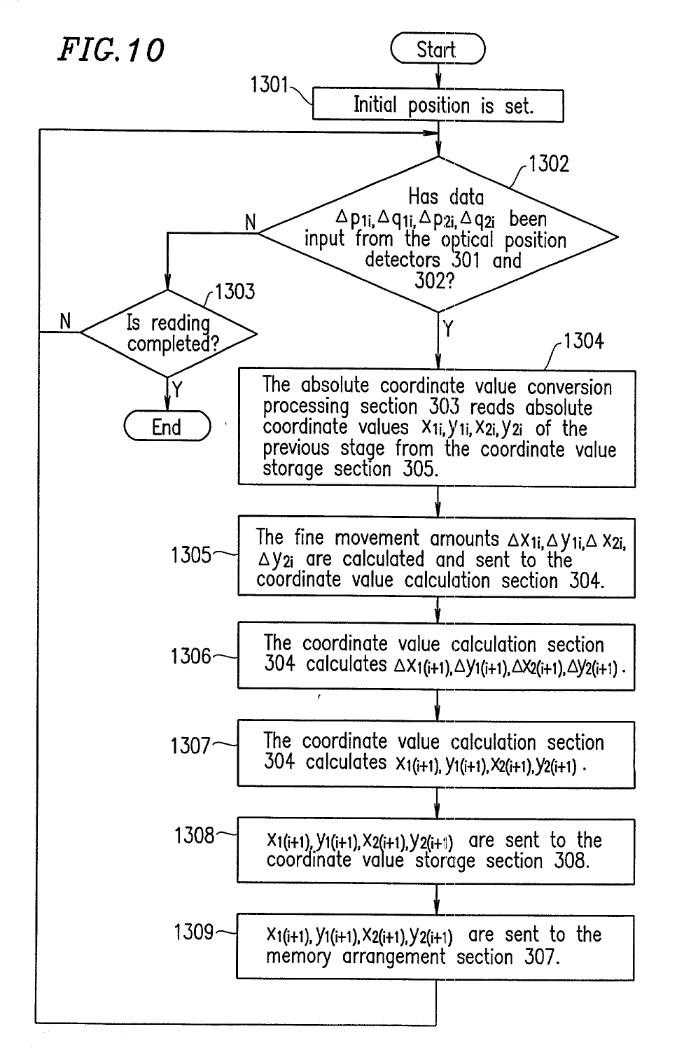

FIG. 10 is a flowchart illustrating a process of calculating absolute coordinate values.

First, the initial position and the initial direction of the handheld scanner 100 are set by driver software (step 1301). It is checked whether or not data has been input from the optical position detectors 301 and 302 (step 1302). When data has been input, the absolute coordinate value conversion processing section 303 reads absolute coordinate values of a previous stage from the coordinate value storage section 305 (in the case of the first cycle of processing, absolute coordinate values of the initial position set by the driver software are read) (step 1304). Based on the data, the absolute coordinate value conversion processing section 303 converts the data on the fine movement amounts of the handheld scanner 100 into data on fine movement amounts on the absolute coordinate system (step 1305). The values on the absolute coordinate system are sent to the coordinate value calculation section 304 (step 1306). The coordinate value calculation section 304 reads the absolute coordinate values of the previous stage as well as receiving the values on the absolute coordinate system from the coordinate value storage section 305, and determines a sum of the two types of data (step 1307). Thus, the post-movement absolute coordinate values are calculated and sent to the coordinate value storage section 308 (step 1308) so as to update the absolute coordinate values in the coordinate value storage section 308 (step 1308). The post-movement absolute coordinate values are also sent to the memory arrangement section 307 (step 1309). When the movement amounts are again input from the optical position detectors 301 and 302, the above-described routine of calculating the absolute coordinate values is repeated. When there is no data on the movement amounts newly input and completion of the image reading is notified by the handheld scanner 100 or the host computer 1502 (FIGS. 4A and 4B) to the user, the process is terminated (step 1303).

As shown in FIG. 6, the image sensor line 406 includes M image sensors arranged in a straight line at an interval D. Therefore, the absolute coordinate value of the data read by the m'th image sensor from the image sensor closest to the optical position detector 301 at time point i is expressed by following expression (8),

$$\{ \begin{matrix}{X}_{m i} = {x}_{1 i} + ( {L}_{e} + ( m - 1 ) \cdot D ) cos {φ}_{i} \\ {Y}_{m i} = {y}_{1 i} + ( {L}_{e} + ( m - 1 ) \cdot D ) sin {φ}_{i}\end{matrix} ( m = 1 \sim M ) . \qquad ( 8 )$$

Once the position of each of the first through M'th image sensors from the image sensor closest to the optical position detector 301 at time point i is determined, the address in the memory 308 in which the image information read at time point i should be stored is determined. The memory arrangement section 307 receives the coordinate value data from the coordinate value calculation section 304 and converts the coordinate value data into an address value of the memory 308. Then, the memory arrangement section 307 stores the image information from each image sensor to the address corresponding to the address value.

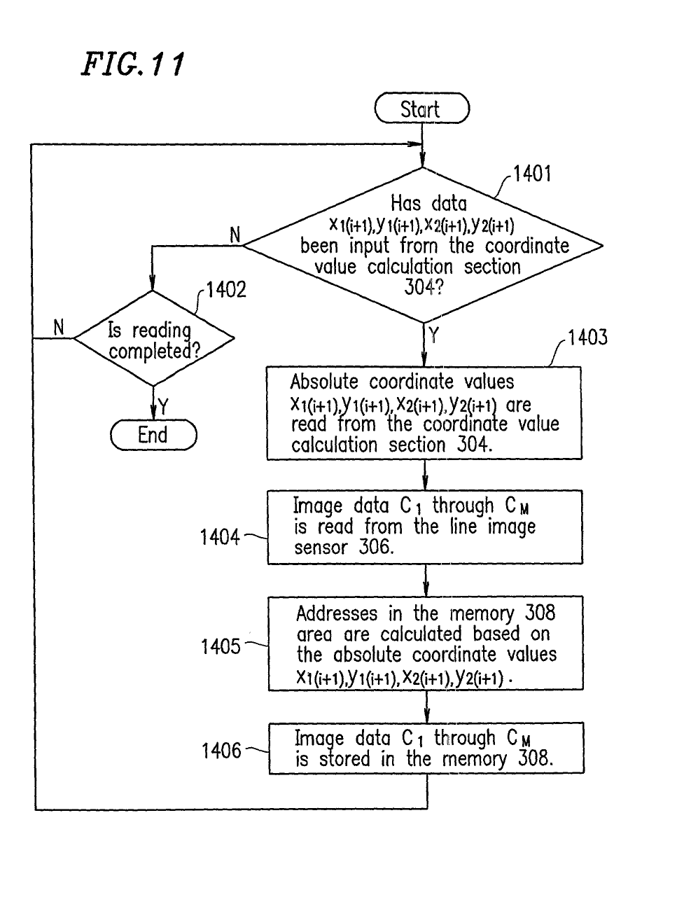

FIG. 11 is a flowchart illustrating a process of sending image information to the memory 308.

First, the memory arrangement section 307 checks whether or not absolute coordinate value data has been input from the coordinate value calculation section 304 (step 1401). When absolute coordinate value data has been input, the memory arrangement section 307 reads the input values (step 1403), and receives a group of image data units from the line image sensor 306 (step 1404). Based on the input values which were read in step 1403, the memory arrangement section 307 calculates an absolute position of each image data unit, and obtains an address in the memory 308 corresponding to the absolute position (step 1405). The memory arrangement section 307 stores the data in the obtained address (step 1407). When absolute coordinate value data is again input, the above-described routine of storing the image data is repeated. When there is no absolute coordinate value data newly input and completion of the image reading is notified by the handheld scanner 100 or the host computer 1502 (FIGS. 4A and 4B) to the user, the process is terminated (step 1402).

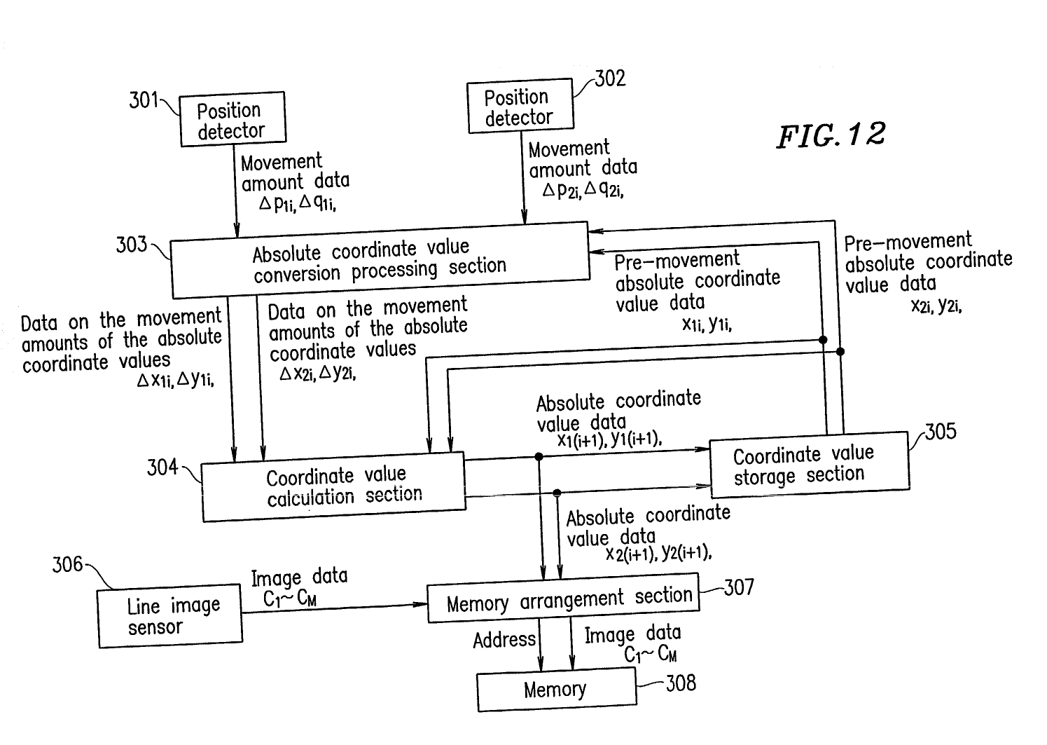

FIG. 12 shows a flow of processing from when an image is taken by the optical position detectors 301 and 302 until the image information is stored in the memory 308. FIG. 12 shows such a flow together with the information which flows between the functional blocks.

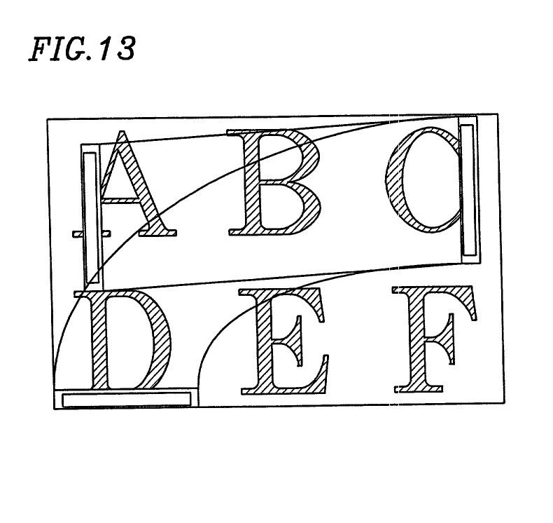

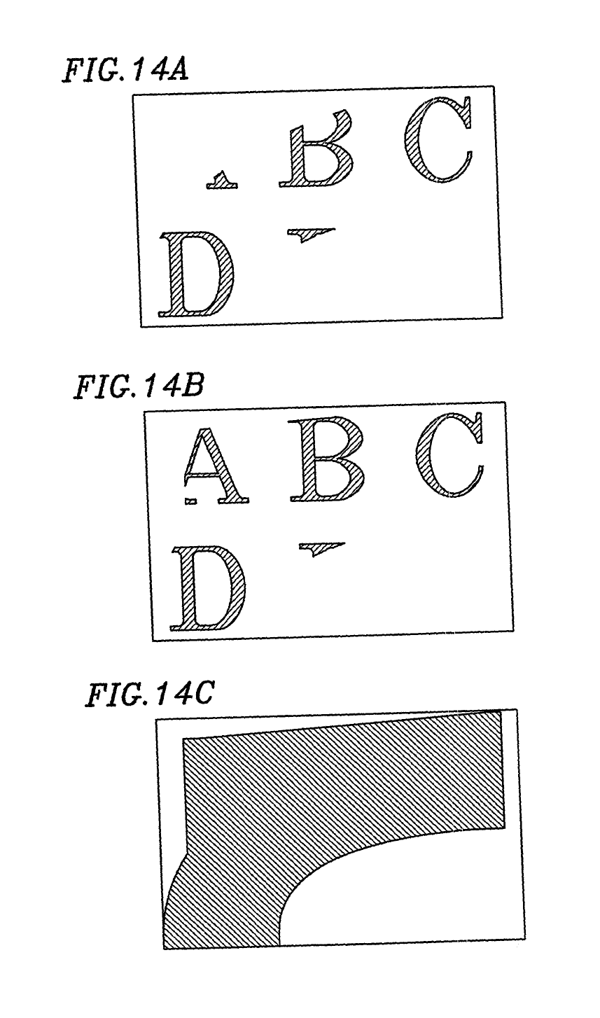

FIG. 13 shows how the handheld scanner 100 is moved on a document. FIGS. 14A and 14B show exemplary image information stored in the memory 308 through the scanning of the document as shown in FIG. 13.

In FIG. 13, image reading starts with a position below the letter “D” at the lower left corner of the document. Then, the handheld scanner 100 is moved in a curve to a position to the right of the letter “C”, and is translated obliquely to a position to the left of the letter “A”. When the handheld scanner 100 has moved from the position below the letter “D” to the position to the right of the letter “C”, the data which has been read by the handheld scanner 100 is as shown in FIG. 14A (namely, substantially the entirety of the letter “D”, which is on the locus of the handheld scanner 100, and a part of each of the letters “A”, “B”, “C” and “E”). When the handheld scanner 100 has moved to the position to the left of the letter “A”, the data which has been read by the handheld scanner 100 is as shown in FIG. 14B (namely, substantially the entirety of the letters “B”, “C” and “D” which are on the locus of the handheld scanner 100, and a part of each of the letters “A” and “E”). The read data is converted into the coordinate values on the absolute coordinate system by the absolute coordinate value conversion processing section 303 and the coordinate value calculation section 304. The data on the absolute coordinate system is arranged in addresses in the memory 308 assigned in accordance with the coordinate value of the x direction and the coordinate value of the y direction.

When the handheld scanner 100 is moved to a position to the left of the letter “A”, there is still an area which has not been read. In the case where the size of the document is known in advance, it is possible to notify the user that the there is still an area which has not been read. In order to realize this, the memory 308 includes an area for storing information on whether the image information is processed or unprocessed in addition to an area for storing the image information. The number of bits required for this additional area is calculated based on the size of the document, which is equal to the number of dots required to read the entire document.

The above-mentioned notification is performed, for example, as follows. Before image reading, all bits are set to “0”. When image information of a coordinate value is obtained after the image reading starts, the corresponding bit is set to “1”. The case where all bits are “1” when the image reading is terminated that indicates that the entire document has been read. The case where at least one bit is “0” indicates that there is still an unread area. This information is notified to the user.

FIG. 14C shows a content of information stored in the memory 308, which indicates whether image information is processed or unprocessed. The hatched portion in FIG. 14C has been read (i.e., the bits corresponding in this portion are “1”) after the handheld scanner 100 is moved from the lower left position to the upper right position and then to the upper left position of the document as described above. The hatched portion is shown on a screen of the host computer 1502 as a plain black area. In this way, the user can scan the document until the entirety of the screen is black. Even when there is a tiny unprocessed area which is difficult to be found by the human eye, such an area can be found by the host computer 1502 reading the information indicating whether image information is processed or unprocessed stored in the memory 308 and indicated to the user.

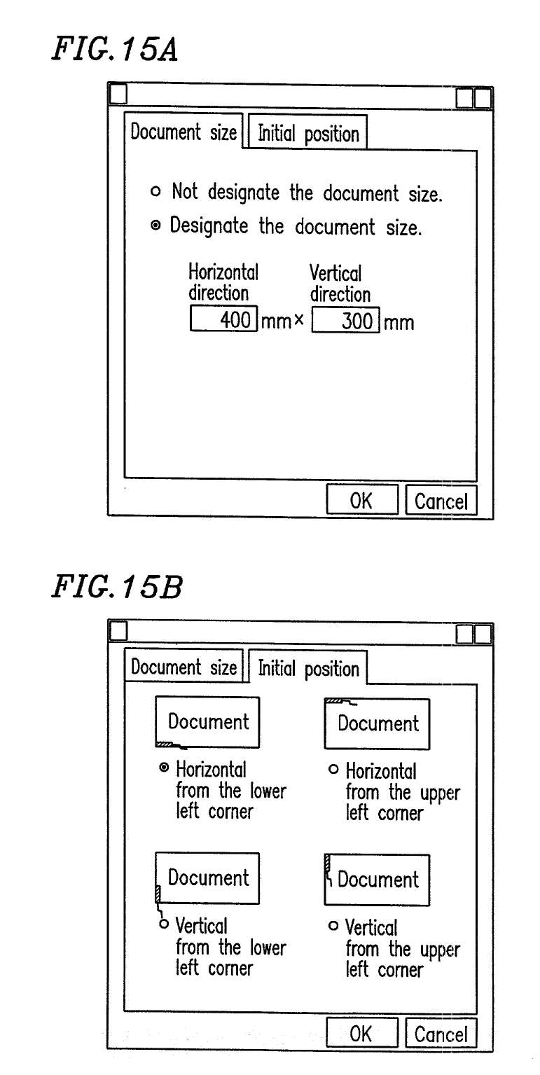

In order for the host computer 1502 to find whether or not there is still an unprocessed area, the host computer 1502 needs to be notified of the size of the document in advance. This is realized by setting the host computer 1502 using driver software as shown in FIG. 15A. First, the user determines whether or not to designate the size of the document. When the user designates the size of the document, the user inputs the size of the document in the horizontal direction and the size of the document in the vertical direction and presses “OK”.

When the document shown in FIG. 13 is not completely read, the handheld scanner 100 located at the position to the left of the letter “A” can be moved across the document until the entirety of the document is read. When a plurality of images are read at the same coordinate value, image synthesis is performed based on the latest image read among the plurality of images. Such image synthesis is performed by the image synthesis section 309. For example, the memory arrangement section 307 of the image synthesis section 309 can overwrite the information stored in the memory 308 with the information of the latest image read. In this manner, when an image of the same coordinate value is read a plurality of times as seen with, for example, a part of the letter “B” and a part of the letter “C”, the latest read image is used. This method of overwriting data has an advantage that since a plurality of images of the same coordinate value need not be stored, the capacity of the memory can be saved. In the case where a part of the document is not correctly read for some reason, for example, due to stains or marks on the document, the read image can be recovered by scanning the same part of the document the second or subsequent times.

In the above description, the handheld scanner 100 is initially located at the lower left corner and placed parallel to the bottom side of the document. Depending on the type of document, the handheld scanner 100 can be initially located at a different position and in a different direction. In whichever position and whichever direction the handheld scanner 100 may be initially located, the document finally read is substantially the same, except that the direction is different and the data is stored in different addresses. It is advantageous to set the initial position and direction of the handheld scanner 100 since an area having no image to read is clearly determined, such that the memory need not have a capacity for that area. Without such initial setting, there is a possibility that the direction of the read image is different from the intended direction. In this case, the read image needs to be processed by the host computer 1502 using a different application or the like. The initial setting eliminates the need for such additional operations. The position and the direction of the handheld scanner 100 can be set mainly using driver software of the host computer 1502. When the host computer 1502 is started, a window as shown in FIG. 15B, for example, is displayed, in which exemplary reading start positions and directions are listed. The user selects the most appropriate position and direction set in the list and presses “OK”. Then, that information is sent to the coordinate value storage section 305, which sets the initial absolute value.

According to the present invention, a large document is entirely scanned by a compact image input apparatus. There is no limit on the direction of scanning the document. In other words, the image can be correctly read even when the compact image input apparatus moves in a direction which is effectively impossible or distorts the image by conventional techniques (for example, when the compact image input apparatus meanders or moves in a curve).

Since mechanical components such as rollers are not necessary in the image input apparatus according to the present invention, there is no part which is worn by long-time use, and malfunction due to adherence of dust or the like does not occur.

In the case where a section for setting the size of the document or initial position and direction of the image input apparatus is provided, the following advantages are provided. No additional step for detecting an unread area is necessary. The memory capacity for the area which does not need to be read can be saved. No extra step of processing, for example, rotating the read image, is required.

Various other modifications will be apparent to and can be readily made by those skilled in the art without departing from the scope and spirit of this invention. Accordingly, it is not intended that the scope of the claims appended hereto be limited to the description as set forth herein, but rather that the claims be broadly construed.

What is claimed is:

1. An image input apparatus having a scanning surface used for scanning a document, the image input apparatus comprising:
an image reading section for reading an image of the document facing the scanning surface;
a position detection section for detecting a moving direction and a movement amount of the image input apparatus; and
a control section for controlling the image reading section and the position detection section so that detection is performed by the position detection section in synchronization with image reading performed by the image reading section.

2. An image input apparatus according to claim 1, wherein:
the scanning surface includes a line area extending in a main scanning direction, and a first reference point and a second reference point each located so as to have a predetermined positional relationship with respect to the line area,
the image reading section includes a line image sensor for reading the image of the document facing the line area, and
the position detection section includes:
a first optical position detector for detecting a movement amount of the first reference point in the main scanning direction and a movement amount of the first reference point in a direction perpendicular to the main scanning direction, and
a second optical position detector for detecting a movement amount of the second reference point in the main scanning direction and a movement amount of the second reference point in a direction perpendicular to the main scanning direction.

3. An image input apparatus according to claim 1, wherein the first reference point is located on a straight line extending in the main scanning direction from one of two ends of the line area, and the second reference point is located on a straight line extending in the main scanning direction from the other end of the line area.

4. An image input apparatus according to claim 1, further comprising an image synthesis section for synthesizing a plurality of images read by the image reading section into one image based on a detection result obtained by the position detection section.

5. An image input apparatus according to claim 4, wherein the image synthesis section calculates a post-movement coordinate value based on a pre-movement coordinate value and the detection result obtained by the position detection section.

6. An image input apparatus according to claim 4, wherein the image reading section reads a plurality of images for one coordinate value, and the image synthesis section performs image synthesis based on the latest image read among the plurality of images read for the one coordinate value.

7. An image input apparatus according to claim 1, further comprising:
a determination section for determining whether or not there is an unread area of the document; and
a notification section for notifying a user of the image input apparatus of the determination result obtained by the determination section.

8. A computer readable recording medium storing a program for causing a computer to execute image synthesis processing, wherein:
the computer is constructed to be connectable to an image input apparatus having a scanning surface used for scanning a document;
the image input apparatus includes:
an image reading section for reading an image of the document facing the scanning surface,
a position detection section for detecting a moving direction and a movement amount of the image input apparatus, and
a control section for controlling the image reading section and the position detection section so that detection is performed by the position detection section in synchronization with image reading performed by the image reading section; and
the image synthesis processing includes the step of synthesizing a plurality of images read by the image reading section into one image based on a detection result obtained by the position detection section.

9. An image synthesis method for performing image synthesis using an image input apparatus having a scanning surface used for scanning a document, the image synthesis method comprising the steps of:
reading an image of the document facing the scanning surface;
detecting a moving direction and a movement amount of the image input apparatus;
detecting the moving direction and the movement amount of the image input apparatus in synchronization with image reading performed by the image reading section; and
synthesizing a plurality of images read by the image reading section into one image based on a detection result obtained by the position detection section.
